(19) United States
(12) Patent Application Publication
(10) Pub. No.: US 2004/0068592 A1
(43) Pub. Date: Apr. 8, 2004

(54) Card adapter

(75) Inventors: Shoichi Higashitani, Yokohama-shi (JP); Satoshi Sakuragi, Yokohama-shi (JP)

Correspondence Address: Keating & Bennett LLP, Suite 312, 10400 Eaton Place, Fairfax, VA, 22030, US

(73) Assignee: Murata Manufacturing Co., Ltd., Nagaokakyo-shi (JP)

(21) Appl. No.: 10/637,631

(22) Filed: Aug. 11, 2003

(30) Foreign Application Priority Data
Oct. 8, 2002 (JP) 2002-295008

(51) Int. Cl. G06F 13/38

(52) U.S. Cl. 710/62

(57) ABSTRACT

A card adapter that is attached to a device in a removable manner and that relays signal connection among the device and other devices includes signal input-and-output members to which the other devices are connected, respectively, in a wired manner and/or a wireless manner, and a host controller having an interface. Each signal input-and-output member is connected to the host controller by a USB. Since USB connection is achieved by a small number of wires, the number of wires of the card adapter decreases. Since the host controller is multifunctional, the number of elements or components of the card adapter is much less than in the case where a separate element or a circuit is provided for each function. Accordingly, the card adapter is produced at a lower cost, and designed and manufactured easily due to the simplified circuit configuration thereof.

### BACKGROUND OF THE INVENTION

1. Field of the Invention

The present invention relates to a card adapter having an interface for relaying signal connection among a plurality of different devices.

2. Description of the Related Art

As shown in FIG. 2A, a card adapter 1 is attached to a personal computer 2 in a removable manner, for example. The card adapter 1 relays signal connection between the personal computer 2 and a device 3. More specifically, the card adapter 1 has a port (not shown) for connecting to the device 3, a terminal (not shown) for signal-connecting to the personal computer 2, and an interface 4 for establishing signal connection between the device 3 and the personal computer 2, for example.

The device 3 can be signal-connected to the personal computer 2 via the card adapter 1 by mounting the card adapter on the personal computer 2 and connecting the device 3 to the card adapter 1.

A plurality of devices 3 can be connected to a card adapter 1 shown in FIG. 2B. FIG. 3A shows an example configuration of this multifunctional card adapter 1. This card adapter 1 has an interface (I/F) unit 4, signal input-and-output members 5A, 5B, and 5C that are independently connected to the devices 3, respectively, and a bus bridge 6. The signal input-and-output members 5A, 5B, and 5C and the I/F unit 4 are connected to the bus bridge 6.

Each of the signal input-and-output members 5A, 5B, and 5C can output and receive a signal to and from the device 3. For example, if a signal is input from the device 3 to one of the signal input-and-output members 5A, 5B, and 5C, the signal input-and-output member outputs the signal to the bus bridge 6. The bus bridge 6 outputs the signal to the I/F unit 4. The I/F unit 4 converts the signal into a signal for the personal computer 2 and outputs the converted signal to the personal computer 2.

If the personal computer 2 transmits a signal to the bus bridge 6 via the I/F unit 4, the bus bridge 6 transmits the signal to any one of the signal input-and-output members 5A, 5B, and 5C. Upon receiving the transmitted signal, any one of the signal input-and-output members 5A, 5B, and 5 outputs the signal to the device 3.

The I/F unit 4 is connected to the bus bridge 6 via a bus, and each of the signal input-and-output members 5A, 5B, and 5C is connected to the bus bridge 6 via a bus.

Such card adapters are disclosed in Japanese Unexamined Patent Application Publication No. 11-259605 and Japanese Unexamined Patent Application Publication No. 2000-222337.

For establishing one bus connection, at least twenty wires are required, for example. Therefore, when a large number of bus connections are required as in the case of FIG. 3A, the number of wires increases. Further, the bus bridge 6 is large in size. Still further, since the dimensions of the card adapter 1 comply with any one of the standards of a PC card, a CF card (a Compact Flash™ card), and so forth, the size of the card adapter 1 is limited. In this case, according to the configuration shown in FIG. 3A, a large number of conducting wires or wiring patterns, and the large bus bridge 6 have to be provided in the card adapter 1 with limited space. Therefore, designing and manufacturing this type of card adapter have been difficult.

FIG. 3B shows another card adapter 1 to which a plurality of devices can be connected. This card adapter 1 has an IC 8 functioning as the plurality of signal input-and-output members 5A, 5B, and 5C, and the bus bridge 6 shown in FIG. 3A. The IC 8 is connected to the I/F unit 4 via a bus.

Accordingly, the card adapter 1 shown in FIG. 3B does not require the plurality of signal input-and-output members 5A, 5B, and 5C, and the bus bridge 6. Therefore, the number of parts used for this card adapter can be reduced. Further, since the number of bus connections is reduced, the number of wires can be significantly reduced.

However, since the IC 8 is not widely used, an IC that is specifically designed for the card adapter 1 must be designed and manufactured. Since designing this type of IC requires much time and high cost, the cost of manufacturing and the price of the card adapter 1 increases.

### SUMMARY OF THE INVENTION

In order to overcome the problems described above, preferred embodiments of the present invention provide a card adapter to which a plurality of devices can be connected and is multifunctional, and can be designed and manufactured easily at low cost.

A card adapter according to a preferred embodiment of the present invention is attached to a device in a removable manner for relaying signal connection among the device and a plurality of other devices. This card adapter includes a plurality of signal input-and-output members to which the plurality of other devices is connected, respectively, in at least one of a wired manner and a wireless manner. Further, the card adapter includes a host controller including an interface to which the signal input-and-output members are connected. This interface is used for signal-connecting the device to which the card adapter is attached to the plurality of other devices. Each of the plurality of signal input-and-output members is connected to the host controller by using USB standard.

According to a preferred embodiment of the present invention, the USB connection can be achieved by using four wires, for example. Subsequently, the number of wires used for the card adapter can be reduced.

The host controller used for preferred embodiments of the present invention has an interface for signal-connecting the device for mounting the card adapter thereon to another device. Further, the host controller can distribute signals among the plurality of signal input-and-output parts. That is to say, the host controller has the same function as that of a bus bridge. Subsequently, the number of parts used for preferred embodiments of the present invention is smaller than in the case where the interface and the bus bridge are provided independently. Since a general-purpose host controller can be used, the cost of manufacturing the parts of the card adapter can be reduced.

As has been described, the circuit configuration of the card adapter can be simplified by reducing the number of wires and parts used therefor. Further, the cost of manufacturing the card adapter can be reduced. Since the card adapter complies with one of the standards of a PC card, a CF card, a PCI card, a mini PCI card, and an ISA card, the size of the card adapter is limited. However, according to preferred embodiments of the present invention, many more signal input-and-output parts can be easily provided in the card adapter by reducing the number of the wires and parts thereof. Therefore, the functions of the card adapter can be expanded.

Other features, elements, characteristics and advantages of the present invention will become apparent from the following detailed description of preferred embodiments thereof with reference to the attached drawings.

### BRIEF DESCRIPTION OF THE DRAWINGS

FIG. 1 shows a card adapter according to a preferred embodiment of the present invention;

FIG. 2A shows an example use of the card adapter;

FIG. 2B shows another example use of the card adapter;

FIG. 3A illustrates an example known card adapter; and

FIG. 3B illustrates another example known card adapter.

### DETAILED DESCRIPTION OF PREFERRED EMBODIMENTS

Preferred embodiments of the present invention will now be described with reference to the attached drawings.

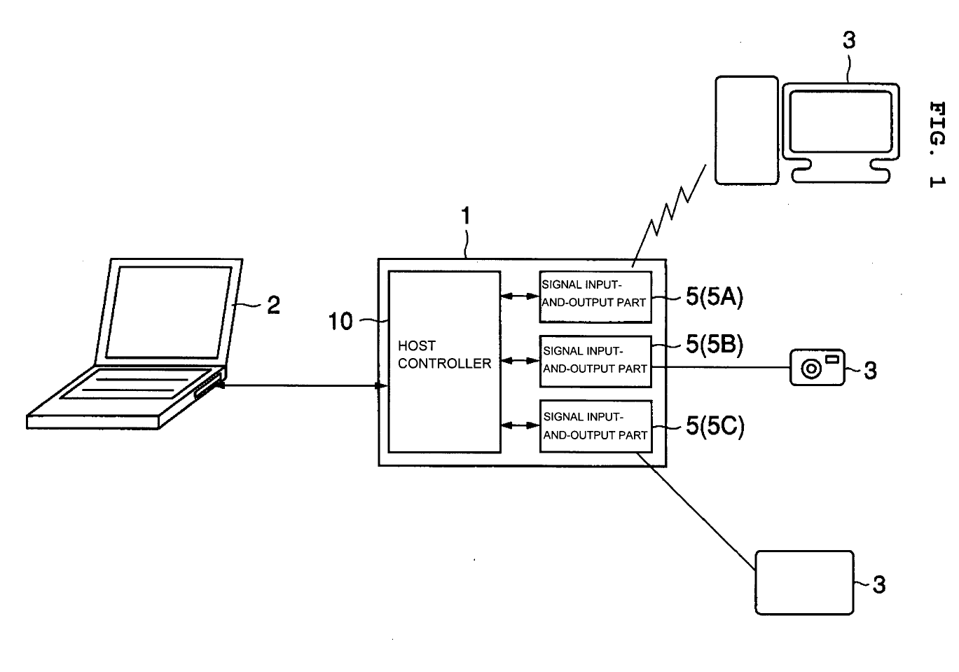

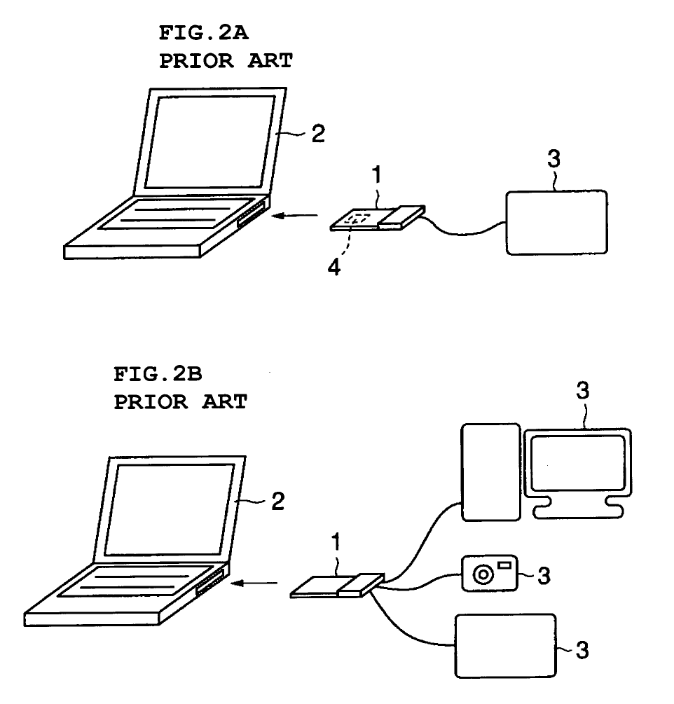

A card adapter 1 according to a preferred embodiment of the present invention can be attached to and detached from a device such as a personal computer. As shown in FIG. 1, the card adapter has a host controller 10 and a plurality of signal input-and-output members 5A, 5B, and 5C. Each of the signal input-and-output members 5A, 5B, and 5C is connected to the host controller 10 with a USB cable. Thus the host controller 10 has a plurality of USB ports.

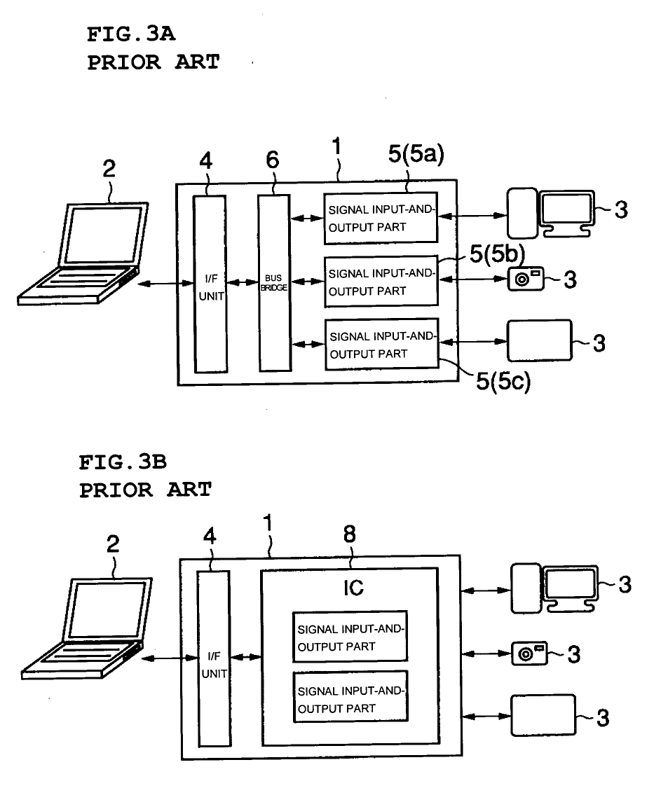

Further, the host controller 10 has an interface for signal-connecting a personal computer 2 to a device 3, and a signal distributor having the same function as that of the bus bridge 6 shown in FIG. 3A.

In this preferred embodiment, the configurations of the interface of the host controller 10, the dimensions and a terminal of the card adapter 1, the terminal being provided for connecting to the personal computer 2, comply with one of the standards of a PC card, a CF card, a PCI card, a mini PCI card, and an ISA card.

Each of the signal input-and-output members 5A, 5B, and 5C outputs and receives a signal to and from the device 3. In this preferred embodiment, the types of signals transmitted from the signal input-and-output parts 5A, 5B, and 5C are preferably different from one another. More specifically, the signal input-and-output member 5A is used for a wireless-LAN-based system, the signal input-and-output member 5B is used for an IEEE 1394-based system, and the signal input-and-output member 5C is used for a USB-based system.

The signal input-and-output member 5A for the wireless-LAN-based system has an antenna and a transceiver circuit that are suitable for wireless communications. The signal input-and-output member 5A is signal-connected to the device 3 according to a wireless-communications standard complying with the wireless-LAN standard. Further, the signal input-and-output member 5A can perform signal conversion so as to establish signal-connection between the wireless-connection side of the device 3 and the USB-connection side of the host controller 10.

The signal input-and-output member 5B for the IEEE 1394-based system has an IEEE 1394 port so as to be signal-connected to the device 3 according to a wired-communications standard complying with the IEEE 1394 standard. Further, the signal input-and-output member 5B can perform signal conversion so that the IEEE 1304-connection side of the device 3 is signal-connected to the USB-connection side of the host controller 10.

As has been described above, the host controller 10 has the plurality of USB ports. Therefore, the signal input-and-output member 5C used for the USB-based system does not require a signal-conversion circuit. That is to say, the signal input-and-output member 5C is formed only of a USB connector (the USB port).

The present invention is not limited to the above-described preferred embodiments, but can be achieved in various forms. For example, in the above-described preferred embodiments, the types of signals transmitted by the signal input-and-output members 5A, 5B, and 5C are preferably different from one another. That is to say, the signal input-and-output members 5A, 5B, and 5C correspond to different types of signal-transmission standards, respectively. However, a plurality of signal input-and-output members used for the USB-based system may be provided. That is to say, a plurality of signal input-and-output members for transmitting signals of the same type may be provided.

Further, according to the above-described preferred embodiments, there are provided three signal input-and-output members. However, two or four signal input-and-output members may be provided.

Further, according to the above-described preferred embodiment, the signal input-and-output members 5A, 5B, and 5C are used for the wireless-LAN-based system, and the IEEE 1394-based system, and the USB-based system, respectively. However, other types of signal input-and-output members used for other types of systems, such as a wired-LAN-based system, a system for infrared communications, and so forth, may be provided.

The present invention is not limited to each of the above-described preferred embodiments, and various modifications are possible within the range described in the claims. An embodiment obtained by appropriately combining technical means disclosed in each of the different preferred embodiments is included in the technical scope of the present invention.

What is claimed is:

1. A card adapter to be attached to a device in a removable manner and relaying signal connection among the device and a plurality of other devices, the card adapter comprising:
a plurality of signal input-and-output members to which the plurality of other devices is connected, respectively, in at least one of a wired manner and a wireless manner; and
a host controller including an interface to which the plurality of signal input-and-output members is connected, the interface being used for signal-connecting the device to which the card adapter is attached to the plurality of other devices;
wherein each of the plurality of signal input-and-output members is connected to the host controller by using USB standard.

2. A card adapter according to claim 1, wherein the dimensions of the card adapter and the interface comply with any one of the standards of a PC card, a CF card, a PCI card, a mini PCI card, and an ISA card.

3. A card adapter according to claim 1, wherein the number of the plurality of signal input-output members is three.

4. A card adapter according to claim 1, wherein the number of the plurality of signal input-output members is two.

5. A card adapter according to claim 1, wherein the number of the plurality of signal input-output members is four.

6. A card adapter according to claim 1, wherein each of the signal input-and-output members is adapted to be used with a different communications system.

7. A card adapter according to claim 3, wherein one of the three signal input-and-output members is adapted to be used with a wireless-LAN-based system, one of the three signal input-and-output members is adapted to be used with a IEEE 1394-based system, and one of the three signal input-and-output members is adapted to be used with a USB-based system.

8. A card adapter according to claim 1, wherein the signal input-and-output members are adapted to use different types of signal-transmission standards from each other.

9. A card adapter according to claim 1, wherein the host controller includes a plurality of USB ports.
